(19) United States
(12) Patent Application Publication
(10) Pub. No.: US 2014/0272490 A1
(43) Pub. Date: Sep. 18, 2014

(54) RECHARGEABLE BATTERY

(71) Applicant: SAMSUNG SDI CO., LTD., Yongin-si (KR)

(72) Inventors: Min-Yeol Han, Yongin-si (KR); Sang-Won Byun, Yongin-si (KR); Soo-Seok Choi, Yongin-si (KR)

(21) Appl. No.: 13/907,571

(22) Filed: May 31, 2013

Related U.S. Application Data
(60) Provisional application No. 61/778,167, filed on Mar. 12, 2013.

(51) Int. Cl. H01M 2/34

(52) U.S. Cl. CPC H01M 2/348
USPC 429/61

(57) ABSTRACT

A rechargeable battery includes: an electrode assembly; a case housing the electrode assembly, the case comprising a side wall and having a case opening; a terminal coupled to the electrode assembly; a lead tab coupled between the terminal and the electrode assembly, the lead tab comprising a cell fuse; and a thermal insulation member at a portion of the lead tab adjacent the case opening and another portion of the lead tab adjacent the side wall.

### CROSS-REFERENCE TO RELATED APPLICATION

This application claims priority to and the benefit of U.S. Provisional Application No. 61/778,167, filed on Mar. 12, 2013 in the U.S. Patent and Trademark Office, the entire content of which is incorporated herein by reference.

### BACKGROUND

1. Field

Embodiments of the present invention relate to a rechargeable battery in which a cell fuse is included in a lead tab.

2. Description of the Related Art

A rechargeable battery is a battery that is capable of repeatedly performing charging and discharging, unlike a primary battery, which is not designed to be recharged. A rechargeable battery with small capacity may be used in a portable small electronic device, such as a mobile phone, a notebook computer, and a camcorder, and a rechargeable battery with large capacity may be used as a power source for driving a motor of a hybrid vehicle and/or an electrical vehicle.

For example, the rechargeable battery includes an electrode assembly for performing charging and discharging, a case for accommodating an electrolyte solution and the electrode assembly, a cap plate coupled to an opening of the case, and lead tabs for electrically connecting the electrode assembly to electrode terminals.

In a rechargeable battery cell, the lead tab includes a cell fuse between a portion connected to the electrode assembly and a portion connected to the electrode terminal. The cell fuse may be blown within a short time in a high-current region, such as an external short circuit.

However, due to heat radiation away from the lead tab and the cell fuse, the cell fuse may not be properly blown in a low-current region (for example, less than 2,000 A) in a current range in which the cell fuse needs to be blown, compared to the high-current region.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide a rechargeable battery, in which a cell fuse is properly blown even in a low-current region in a current range in which the cell fuse needs to be blown, by suppressing heat radiation away from a lead tab and the cell fuse.

An exemplary embodiment of the present invention provides a rechargeable battery including: an electrode assembly; a case housing the electrode assembly, the case comprising a side wall and having a case opening; a terminal coupled to the electrode assembly; a lead tab coupled between the terminal and the electrode assembly, the lead tab comprising a cell fuse; and a thermal insulation member at a portion of the lead tab adjacent the case opening and another portion of the lead tab adjacent the side wall.

The thermal insulation member may include at least a first thermal insulation member adjacent the case opening and a second thermal insulation member adjacent the side wall.

The second thermal insulation member may be between the lead tab and the case, wherein the second thermal insulation member may be attached to the lead tab with a retainer coupled to the lead tab.

The second thermal insulation member may be between the lead tab and the retainer.

The lead tab may have a fuse opening at the cell fuse.

The thermal insulation member may cover the cell fuse.

The thermal insulation member may include: a plate covering the cell fuse and the portion of the lead tab adjacent the cell fuse; and a protrusion extending from the plate into the fuse opening.

The thermal insulation member may be secured to the lead tab by the protrusion.

A retainer may be between the lead tab and an inner surface of the case to support the electrode assembly in the case.

The retainer may include a hook engaging the lead tab with the thermal insulation member between the retainer and the lead tab.

The retainer may include polypropylene.

The thermal insulation member may be around the lead tab.

The thermal insulation member may be integrally molded around the lead tab and in an opening through the lead tab at the cell fuse.

The lead tab may include: a first connection portion coupled to the electrode assembly; and a second connection portion coupled to the terminal, wherein the cell fuse may be at the second connection portion.

The rechargeable battery may further include a thermal insulation film around a portion of the first connection portion.

The thermal insulation member may include a thermal insulation film.

The thermal insulation member may include polyimide.

According to exemplary embodiments of the present invention, heat conduction from the lead tab to the cell fuse may be properly maintained by covering one portion of the lead tab adjacent to the cell fuse with the heat insulation member, so that the cell fuse may be properly blown even in the low-current region in the current range, in which the cell fuse needs to be blown.

### BRIEF DESCRIPTION OF THE DRAWINGS

FIG. 1 is a perspective view of a rechargeable battery according to a first exemplary embodiment of the present invention.

FIG. 2 is a cross-sectional view taken along the line II-II of FIG. 1.

FIG. 3 is a perspective view of a lead tab of FIG. 2.

FIG. 4 is a cross-sectional view taken along the line IV-IV of FIG. 3.

FIG. 5 is a perspective view of a lead tab used in a rechargeable battery according to a second exemplary embodiment of the present invention.

FIG. 6 is a cross-sectional view taken along the line VI-VI of FIG. 5.

FIG. 7 is a cross-sectional view of a lead tap used for a rechargeable battery according to a third exemplary embodiment of the present invention.

### DETAILED DESCRIPTION OF EMBODIMENTS

Hereinafter, embodiments of the present invention will be described more fully with reference to the accompanying drawings, in which exemplary embodiments of the invention are shown. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

FIG. 1 is a perspective view of a rechargeable battery according to a first exemplary embodiment of the present invention, and FIG. 2 is a cross-sectional view taken along the line II-II of FIG. 1. Referring to FIGS. 1 and 2, a rechargeable battery 100 according to the first exemplary embodiment includes an electrode assembly 10 for charging and discharging current, a case 15 for accommodating (e.g., housing, substantially enclosing, or surrounding) the electrode assembly 10 and an electrolyte solution, a cap plate 20 coupled to an opening of the case 15, electrode terminals 21 and 22 installed in (e.g., coupled to) the cap plate 20, and lead tabs 51 and 52 for coupling the electrode terminals 21 and 22 to the electrode assembly 10.

Referring to FIG. 2, the electrode assembly 10 is formed by positioning electrodes (for example, a negative electrode 11 and a positive electrode 12) on respective (e.g., opposing) surfaces of a separator 13, which is an insulator, and winding or rolling the negative electrode 11, the separator 13, and the positive electrode 12 in a jelly-roll state.

The positive electrode and negative electrode 11 and 12 include coated regions 11a and 12a, respectively, in which a respective active material is applied to a current collector of a metal plate. The positive electrode and negative electrode 11 and 12 further include uncoated regions 11b and 12b exposed at opposing ends of the electrode assembly 10, respectively, which are formed as exposed current collectors because an active material is not applied thereto.

The uncoated region 11b of the negative electrode 11 is located at one end of the negative electrode 11 along the wound negative electrode 11. The uncoated region 12b of the positive electrode 12 is located at one end of the positive electrode 12 along the wound positive electrode 12. Further, the uncoated regions 11b and 12b are disposed at both (e.g., opposing) ends of the electrode assembly 10, respectively.

The case 15 has an approximately or generally cuboid shape so as to provide a space or internal cavity for accommodating the electrode assembly 10. An opening of the case 15 is formed at one side of the cuboid, so that the electrode assembly 10 may be inserted in the internal space from the outside.

The cap plate 20 is installed in the opening (or positioned to substantially cover the opening) of the case 15 to substantially seal the case 15. For example, the case 15 and the cap plate 20 may be formed of aluminum to be welded to each other. That is, the electrode assembly 10 is inserted in the case 15, and then the cap plate 20 may be welded to the opening of the case 15.

Further, the cap plate 20 includes one or more openings, and for example, includes terminal holes H1 and H2 and a vent hole 24. The electrode terminals 21 and 22 are installed at the terminal holes H1 and H2 of the cap plate 20 to be electrically coupled to the electrode assembly 10.

That is, the electrode terminals 21 and 22 are electrically coupled to the negative electrode 11 and the positive electrode 12 of the electrode assembly 10. Accordingly, power stored in the electrode assembly 10 may be withdrawn to the outside of the case 15 through the electrode terminals 21 and 22.

The electrode terminals 21 and 22 include plate terminals 21c and 22c positioned outside of the cap plate 20 at the terminal holes H1 and H2, respectively.

Rivet terminals 21a and 22a are electrically coupled to the electrode assembly 10 and fastened (e.g., coupled or attached) to the plate terminals 21c and 22c while passing through the terminal holes H1 and H2.

The plate terminals 21c and 22c have through-holes H3 and H4. The rivet terminals 21a and 22a are inserted or positioned in the through-holes H3 and H4 while passing through the terminal holes H1 and H2 toward an upper end of the rechargeable battery 100. The electrode terminals 21 and 22 further include flanges 21b and 22b integrally and widely formed with the rivet terminals 21a and 22b at an internal side of the cap plate 20. The flanges 21b and 22b have cross-sectional widths greater than the corresponding widths of the terminal holes H1 and H2, respectively, to substantially secure the electrode terminals 21 and 22 to the case 15.

An external insulation member 31 interposed between the plate terminal 21c and the cap plate 20 electrically insulates the plate terminal 21c from the cap plate 20 at a side of the electrode terminal 21 coupled to the negative electrode 11. That is, the cap plate 20 maintains a state in which the cap plate 20 is electrically insulated from the electrode assembly 10 and the negative electrode 11.

The insulation member 31 and the plate terminal 21c are fastened (e.g., coupled or attached) to an upper end of the rivet terminal 21a by coupling the insulation member 31 and the plate terminal 21c to the upper end of the rivet terminal 21a and riveting or welding the upper end. The plate terminal 21c is installed outside the cap plate 20 with the insulation member 31 interposed between the plate terminal 21c and the cap plate 20.

A conductive top plate 46 is interposed between the plate terminal 22c and the cap plate 20 and is electrically coupled between the plate terminal 22c and the cap plate 20 at a side of the electrode terminal 22 coupled to the positive electrode 12. That is, the cap plate 20 maintains a state where the cap plate 20 is electrically coupled to the electrode assembly 10 and the anode electrode 12.

The top plate 46 and the plate terminal 22c are fastened (e.g., coupled or attached) to an upper end of the rivet terminal 22a by coupling the top plate 46 and the plate terminal 22c to the upper end of the rivet terminal 22a and riveting or welding the upper end. The plate terminal 22c is installed (e.g., located or positioned) outside the cap plate 20 with the top plate 46 interposed between the plate terminal 22c and the cap plate 20.

Gaskets 36 and 37 are installed in spaces between the rivet terminals 21a and 22a of the electrode terminals 21 and 22 and internal surfaces of the terminal holes H1 and H2 of the cap plate 20, to seal and electrically insulate spaces between the rivet terminals 21a and 22a and the cap plate 20.

The gaskets 36 and 37 extend between the flanges 21b and 22b and the internal surface of the cap plate 20 to further seal and electrically insulate spaces between the flanges 21b and 22b and the cap plate 20. That is, the gaskets 36 and 37 prevent or substantially prevent the electrolyte solution from being leaked through the terminal holes H1 and H2 after installing the electrode terminals 21 and 22 in the cap plate 20.

The lead tabs 51 and 52 electrically couple the electrode terminals 21 and 22 to the negative and positive electrodes 11 and 12 of the electrode assembly 10, respectively. That is, the lead tabs 51 and 52 are coupled to lower ends of the rivet terminals 21a and 22a while being supported by the flanges 21b and 22b by coupling the lead tabs 51 and 52 to the lower ends of the rivet terminals 21a and 22a and caulking the lower ends.

The lead tabs 51 and 52 further include cell fuses 71 and 72 for blocking current between the electrode terminals 21 and 22 and the electrode assembly 10 when a temperature of or a current through the lead tab 51 or 52 exceeds a threshold temperature or current. The cell fuses 71 and 72 may be formed at the sides of the negative electrode 11 and the positive electrode 12 of the electrode assembly 10. Alternatively, the cell fuses 71 and 72 may be selectively formed at the side of the negative electrode 11 or the positive electrode 12.

The cell fuses 71 and 72 are formed so as to be properly blown in a current range of the rechargeable battery cell 100 in which the cell fuses 71 and 72 may be blown in a high-current region, such as an external short, within a short time and even in a low-current region. To this end, for example, heat insulation members 81 and 82 are further included in the lead tabs 51 and 52.

The heat insulation members 81 and 82 are located in a structure in which the heat insulation members 81 and 82 are spaced apart from the case 15 to cover portions of the lead tabs 51 and 52 adjacent to the cell fuses 71 and 72. Accordingly, the heat insulation members 81 and 82 suppress heat radiation out of the lead tabs 51 and 52 and facilitate thermal conduction through the lead tabs 51 and 52 and through the cell fuses 71 and 72 to facilitate proper operation of the cell fuses 71 and 72. That is, the heat insulation members 81 and 82 are adapted to prevent thermal dissipation out of or away from the lead tabs 51 and 52 at the cell fuses 71 and 72. For example, the heat insulation members 81 and 82 may be formed of polyimide having excellent heat resistance and impact resistance.

In the meantime, the insulation members 61 and 62 are installed between the lead tabs 51 and 52 and the cap plate 20, respectively, to electrically insulate the lead tabs 51 and 52 from the cap plate 20. Further, one side of each of the insulation members 61 and 62 is coupled to the cap plate 20 and the other side of each of the insulation members 61 and 62 surrounds a portion of the lead tabs 51 and 52, the rivet terminals 21a and 22a, and the flanges 21b and 22b, respectively, to stabilize a connection structure thereof.

The vent hole 24 is substantially sealed and closed with a vent plate 25 so as to enable discharge of internal pressure and generated gas of the rechargeable battery cell 100. When the internal pressure of the rechargeable battery cell 100 reaches a pressure (e.g., a predetermined pressure), the vent plate 25 is incised to open the vent hole 24. The vent plate 25 has a notch 25a to facilitate the incision.

In the meantime, retainers 91 and 92 are interposed between opposing ends of the electrode assembly 10 and the case 15 to protect the electrode assembly 10 from external impact. That is, the retainers 91 and 92 may support the lead tabs 51 and 52 coupled to the electrode terminals 21 and 22, so that the electrode assembly 10 may be spaced apart from the case 15 to be buffered and supported. For example, the retainers 91 and 92 may be formed of polypropylene, which is light, has a high softening point, and excellent processability.

FIG. 3 is a perspective view of a lead tab of FIG. 2, and FIG. 4 is a cross-sectional view taken along the line IV-IV of FIG. 3. Since the lead tabs 51 and 52 are formed in the same structure, the lead tab 51 coupled to the negative electrode 11 of the electrode assembly 10 will be described hereinafter as an example for convenience of the description.

Referring to FIGS. 3 and 4, the lead tab 51 includes a first connection portion 511 coupled to the uncoated region 11b of the negative electrode of the electrode assembly 10, and a second connection portion 512 bent from the first connection portion 511 to be coupled to the rivet terminal 21a of the electrode terminal 21.

The second connection portion 512 includes through-openings 73 and 74 to be coupled to a lower end of the rivet terminal 21a and a lower protrusion 21d of the flange 21b. The cell fuse 71 is formed with a narrower area (e.g., smaller surface area) than that of a neighboring area in the second connection portion 512 to have higher electric resistance than that of the neighboring area.

The cell fuse 71 increases resistance by piercing a hole H5 having an area (e.g., a predetermined area) in the second connection portion 512 and removing a conductive portion, so that it is possible to interrupt or reduce current flow between the first and second connection portions 511 and 512. That is, the second connection portion 512 of the lead tab 51 has a smaller surface area at the cell fuse 71, because of the hole H5 formed through the second connection portion 512, thereby increasing the electrical resistance of the second connection portion 512 at the cell fuse 71.

The heat insulation member 81 covers at least one part between the first connection portion 511 and the second connection portion 512 to suppress radiation of the heat away the lead tab 51, such that the heat conducted from the lead tab 51 is applied to the cell fuse 71. For convenience, in the first exemplary embodiment, a first heat insulation block 811 included in the first connection portion 511 and a second heat insulation block 812 included in the second connection portion 512 will be described.

The first heat insulation block 811 is interposed at least between the first connection portion 511 and the retainer 91, to form a heat insulation structure. That is, the first heat insulation block 811 insulates heat at one surface of the first connection portion 511 to increase or improve smooth or proper heat conduction from the first connection portion 511 to the second connection portion 512.

The second heat insulation block 812 covers at least a part of the cell fuse 71 in the second connection portion 512 to form a heat insulation structure. That is, the second heat insulation block 812 insulates the cell fuse 71 from heat at one surface of the second connection portion 512 to maximally suppress or improve suppression of heat radiation away from the second connection portion 512 around the cell fuse 71. Further, the second heat insulation block 812 may prevent an arc or spark from being generated when the cell fuse 71 is melted to be blown.

More specifically, the first heat insulation block 811 is separately formed from the first connection portion 511 and disposed between the first connection portion 511 and the retainer 91 to provide heat insulation. Further, the first heat insulation block 811 may be fixed (e.g., coupled, secured, or attached) to the one surface of the first connection portion 511 by a mutual fastening force, in which the retainer 91 is fastened to the first connection portion 511 using a hook or clip.

The second heat insulation block 812 is formed as a plate 814, including a protrusion 813 extending from one surface of the plate 814, to cover a portion of a surface of the second connection portion 512 facing the electrode assembly 10 with the plate 814. Further, the protrusion 813 is inserted in the hole H5 forming the cell fuse 71, such that the second heat insulation block 812 may be fixed to one surface of the second connection portion 512 by forcible fitting force of the protrusion 813 and the hole H5. That is, the protrusion 813 may be snapped or clipped into the hole H5 to retain the second heat insulation block 812 against one surface of the second connection portion 512.

The first heat insulation block 811 insulates heat from the first connection portion 511, and the second heat insulation block 812 insulates heat from the second connection portion 512 and the cell fuse 71, so that the heat conduction from the lead tab 51 to the cell fuse 71 may be properly maintained.

Accordingly, the cell fuse 71 may be properly blown even in the low-current region in the current range, in which the cell fuse 71 needs to be blown, as well as the high-current region. That is, the cell fuse 71 may be blown before the retainer 91 is melted.

Hereinafter, various exemplary embodiments of the present invention will be described. The same constitution as that of the first exemplary embodiment and the aforementioned exemplary embodiment will be omitted, and different constitutions will be described.

FIG. 5 is a perspective view of a lead tab used in a rechargeable battery according to a second exemplary embodiment of the present invention, and FIG. 6 is a cross-sectional view taken along the line VI-VI of FIG. 5.

Referring to FIGS. 5 and 6, in a heat insulation member 83 of the second exemplary embodiment, a first heat insulation molding portion 831 is integrally formed around a periphery or perimeter of a first connection portion 511 corresponding to the retainer 91 by insert molding the first connection portion 511. That is, the first heat insulation molding portion 831 provides heat insulation around the first connection portion 511 (e.g., at both opposing flat surfaces and the side surfaces of the first connection portion 511) and thus may have a higher heat insulation efficiency compared to the first heat insulation block 811 of the first exemplary embodiment.

A second heat insulation molding portion 832 is integrally formed around a periphery or perimeter of a cell fuse 71 and through a hole H5 forming the cell fuse 71 by insert molding a second connection portion 512. That is, the second heat insulation portion 832 provides heat insulation around the second connection portion 512 (e.g., over both opposing flat surfaces and the side surfaces of the second connection portion 512) and through the hole H5 at the cell fuse 71 and thus may have a higher heat insulation efficiency compared to the second heat insulation block 812 of the first exemplary embodiment.

The first heat insulation molding portion 831 insulates the heat at both opposing flat surfaces and the side surfaces of the first connection portion 511, and the second heat insulation molding portion 832 insulates heat at both opposing flat surfaces and the side surfaces of the second connection portion 512 and the cell fuse 71, so that heat conduction from the lead tab 51 to the cell fuse 71 may be more properly maintained. Further, the second heat insulation molding portion 832 may prevent an arc or spark from being generated when the cell fuse 71 is melted to be blown.

FIG. 7 is a cross-sectional view of a lead tab used in a rechargeable battery according to a third exemplary embodiment of the present invention. Referring to FIG. 7, in a heat insulation member 84 in the third exemplary embodiment, a first heat insulation covering portion 841 is formed by covering a periphery (e.g., around a portion of the external surfaces) of a first connection portion 511 corresponding to the retainer 91 with an insulation film. That is, the first heat insulation covering portion 841 covers a portion of the external surfaces of the first connection portion 511, so that a manufacturing process is simpler than that of the first heat insulation block 831 of the second exemplary embodiment.

A second heat insulation covering portion 842 covers a periphery of the second connection portion 512 (e.g., a portion of the external surfaces of the second connection portion 512) and the cell fuse 71 with the heat insulation film. That is, the second heat insulation covering portion 842 covers a portion of the external surfaces of the second connection portion 512 and the cell fuse 71, thereby achieving a simpler manufacturing process than that of the second heat insulation molding portion 832 of the second exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims, and their equivalents.

<Description of Some of the Reference Numerals>

| | |
|---|---|
| 10: Electrode assembly | 11: Negative electrode |
| 11a, 12a: Coated region | 11b, 12b: Uncoated |
| | region |
| 15: Case | 20: Cap plate |
| 21, 22: Electrode terminal | 21a, 22a: Rivet terminal |
| 21b, 22b: Flange | 21c, 22c: Plate terminal |
| 21d: Protrusion | 24: Vent hole |
| 25: Vent plate | 25a: Notch |
| 31: Insulation member | 36, 37: Gasket |
| 46: Top plate | 51, 52: Lead tab |
| 71, 72: Cell fuse | 73, 74: Through-opening |
| 81, 82, 83, 84: Insulation member | 91, 92: Retainer |
| 100: Rechargeable battery cell | |
| 511, 512: First and second connection portion | |
| 811: First heat insulation block | 812: Second heat |
| | insulation block |
| 813: Protrusion | 814: Plate |
| 831: First heat insulation molding portion | |
| 832: Second heat insulation molding portion | |
| 841: First heat insulation covering portion | |
| 842: Second heat insulation covering portion | |
| H1, H2: Terminal hole | H3, H4: Through-hole |
| H5: Hole | |

What is claimed is:

1. A rechargeable battery comprising:
an electrode assembly;
a case housing the electrode assembly, the case comprising a side wall and having a case opening;
a terminal coupled to the electrode assembly;
a lead tab coupled between the terminal and the electrode assembly, the lead tab comprising a cell fuse; and
a thermal insulation member at a portion of the lead tab adjacent the case opening and another portion of the lead tab adjacent the side wall.

2. The rechargeable battery of claim 1, wherein the thermal insulation member comprises at least a first thermal insulation member adjacent the case opening and a second thermal insulation member adjacent the side wall.

3. The rechargeable battery of claim 2, wherein the second thermal insulation member is between the lead tab and the case, wherein the second thermal insulation member is attached to the lead tab with a retainer coupled to the lead tab.

4. The rechargeable battery of claim 3, wherein the second thermal insulation member is between the lead tab and the retainer.

5. The rechargeable battery of claim 1, wherein the lead tab has a fuse opening at the cell fuse.

6. The rechargeable battery of claim 5, wherein the thermal insulation member covers the cell fuse.

7. The rechargeable battery of claim 6, wherein the thermal insulation member comprises:
a plate covering the cell fuse and the portion of the lead tab adjacent the cell fuse; and
a protrusion extending from the plate into the fuse opening.

8. The rechargeable battery of claim 7, wherein the thermal insulation member is secured to the lead tab by the protrusion.

9. The rechargeable battery of claim 1, further comprising a retainer between the lead tab and an inner surface of the case to support the electrode assembly in the case.

10. The rechargeable battery of the claim 9, wherein the retainer comprises a hook engaging the lead tab with the thermal insulation member between the retainer and the lead tab.

11. The rechargeable battery of claim 9, wherein the retainer comprises polypropylene.

12. The rechargeable battery of claim 1, wherein the thermal insulation member is around the lead tab.

13. The rechargeable battery of claim 1, wherein the thermal insulation member is integrally molded around the lead tab and in an opening through the lead tab at the cell fuse.

14. The rechargeable battery of claim 1, wherein the lead tab comprises:
a first connection portion coupled to the electrode assembly; and
a second connection portion coupled to the terminal, wherein the cell fuse is at the second connection portion.

15. The rechargeable battery of claim 14, further comprising a thermal insulation film around a portion of the first connection portion.

16. The rechargeable battery of claim 1, wherein the thermal insulation member comprises a thermal insulation film.

17. The rechargeable battery of claim 1, wherein the thermal insulation member comprises polyimide.
